(19) United States
(12) Patent Application Publication
(10) Pub. No.: US 2006/0201340 A1
(43) Pub. Date: Sep. 14, 2006

(54) Buffer interface for fruit ripening display

(76) Inventors: Chia C. Chiang, Los Angeles, CA (US); Brent D. Sokol, Los Angeles, CA (US)

Correspondence Address: BRENT SOKOL, 418 N. LAJOLLA, LOS ANGELES, CA, 90048, US

(21) Appl. No.: 11/368,364

(22) Filed: Mar. 2, 2006

Related U.S. Application Data
(63) Continuation of application No. 11/361,323, filed on Feb. 23, 2006.
(60) Provisional application No. 60/656,155, filed on Feb. 23, 2005.

(51) Int. Cl. A01J 15/14

(52) U.S. Cl. 99/467; 99/275

(57) ABSTRACT

Apparatuses and methods for interfacing the vents and display parts of a fruit ripening display are provided. In one aspect, a fruit ripening display comprises one or more display parts, one or more vents, and a butter interface that comprises an air flow channeler. In another aspect, a fruit ripening display comprises one or more display parts, one or more vents, and a buffer interface that is grooved to accept at least one of said one or more fruit ripening display parts.

### CROSS-REFERENCE TO RELATED APPLICATION

This is a continuation of U.S. Application Ser. No. ______ of the same title filed Feb. 23, 2006, and claims priority to and benefit of that application and, through it, U.S. Provisional application No. 60/656,155, filed Feb. 23, 2005. Both applications are incorporated herein by reference.

### BACKGROUND

The use of glass and other delicate material for fruit ripening displays as disclosed in copending U.S. patent application Ser. No. 10/920,044, filed on Aug. 16, 2004, and incorporated herein by reference, creates difficulty when the ripening displays use metal and other hard materials in their other parts. In particular, the use of vents, more particularly metal vents, as disclosed in that application, creates a hard interface with the glass material. Since 1) the glass in the disclosed fruit ripening displays may be relatively thin to permit clear viewing of the fruit, 2) the vent may be elevated relative to the fruit support surface so that the fruit resting on the fruit support surface will be biased not to cover the vent holes and 3) the vent may be made of stainless steel, carbon steel, or other hard substance to ensure durability and lack of chemical interaction with fruit acids, there is now a need for a buffer interface between these fruit ripening display vents and the display parts. Further, the buffer interface may beneficially streamline air flow between the ripening chamber and the outer atmosphere by, for example, sealing off any spaces that may interfere with proper circulation through the fruit ripener display vent.

### SUMMARY

Applicants provide various methods and apparatuses that permit beneficial venting of fruit ripening displays. In one aspect, a fruit ripening display comprises one or more display parts, one or more vents, and a butter interface between at least one part and at least one vent that comprises an air flow channeler. In another aspect, a fruit ripening display comprises one or more display parts, one or more vents, and a buffer interface that is grooved to accept at least one of said one or more fruit ripening display parts. In another aspect, the fruit ripening display vent comprises one or more protrusions that comprise a buffer interface locator. Each of these aspects may be used in permutation and combination with one another. Further embodiments as well as modifications, variations and enhancements are also described herein.

### BRIEF DESCRIPTION OF THE DRAWINGS

FIG. 1 is a perspective view of a vent-buffer interface assembly.

FIG. 2 is an exploded perspective view of the vent-buffer interface assembly of FIG. 1

FIG. 3 is a cross-section of the vent-buffer interface assembly of FIG. 1 taken vertically through its center line.

FIG. 4 is a perspective view of a vent-buffer interface assembly.

FIG. 5 is an exploded perspective view of the vent-buffer interface assembly of FIG. 4.

FIG. 6 is a cross-section of the vent-buffer interface assembly of FIG. 5 taken vertically through its center line.

FIG. 7 is a bottom view of a vent having an inward hole slope.

FIG. 8 is a cross-section of the vent of FIG. 7 taken vertically through its center line.

FIG. 9 is a perspective view of a fruit ripening display employing a buffer interface.

FIG. 10 is a side elevation view of the fruit ripening display of FIG. 9.

FIG. 11 is a perspective view of a fruit ripening display employing a buffer interface.

FIG. 12 is a side elevation view of the fruit ripening display of FIG. 11.

FIG. 13 is a side elevation view of a fruit ripening display employing an alternate vent-display part connector.

FIG. 14 is a side elevation view of a fruit ripening display employing a vent that consists or comprises the interface material.

FIG. 15 is a side elevation view of a cross-section of a buffer interface with groove and lock.

FIG. 16 is a see-through top view of the buffer interface of FIG. 15.

FIG. 17 is a side elevation view of a cross-section of a buffer interface with groove and lock.

FIG. 18 is a see-through top view of the buffer interface of FIG. 17.

### DETAILED DESCRIPTION

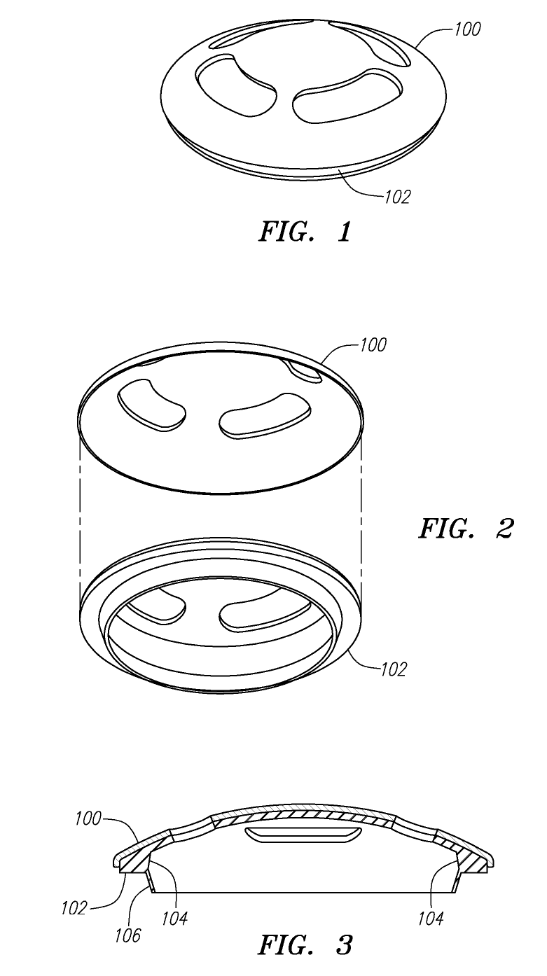

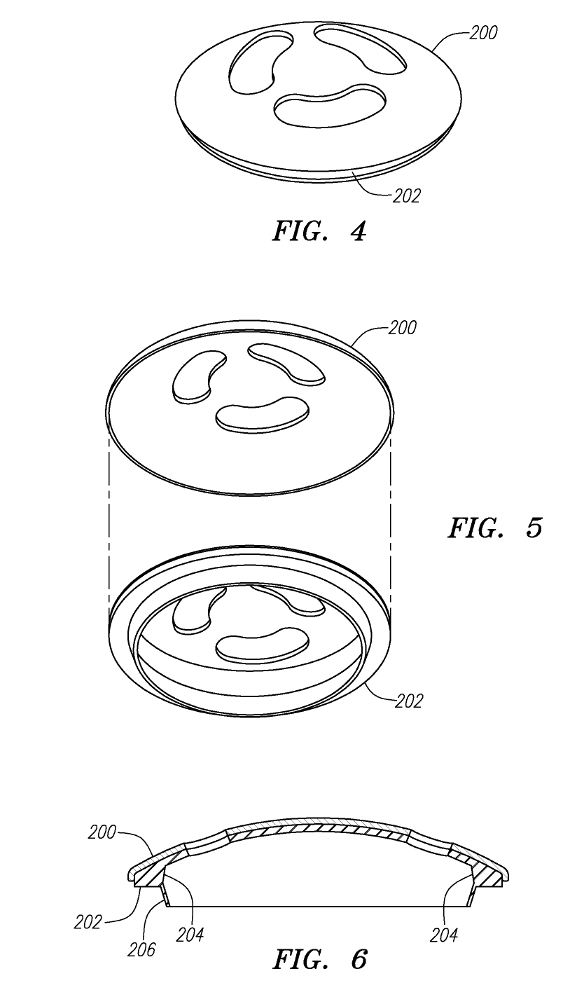

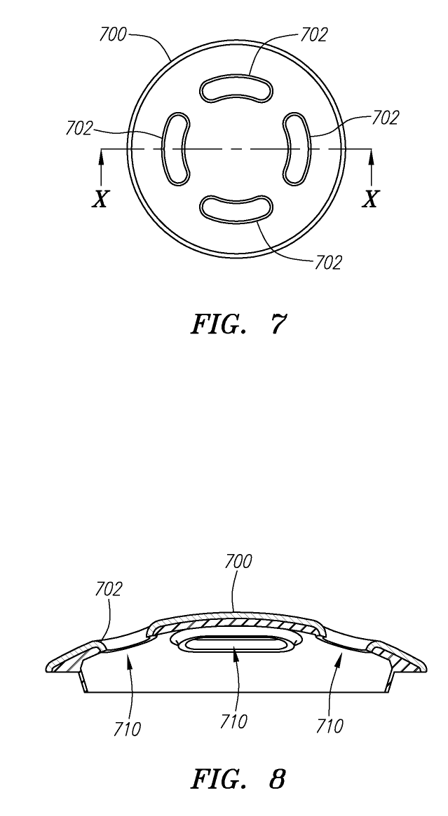

FIG. 1 shows a perspective view of a fruit ripening display vent 100 having four holes. FIG. 2 shows a perspective exploded view of the vent of FIG. 1 with a buffer interface 102. The buffer interface has a substantially reciprocal contour relative to the underside of the vent 100. Indeed, they may fit flush against one another. They may be connected together by a connector such as glue or rivet or simply pressure fit together. FIG. 3 shows a cross-section of vent 100 comprising buffer interface 102. Preferably, buffer interface 102 contains director portions that create directed gas flow between the inside and outside of the ripening display chamber. For example, the buffer interface 102 may comprise flow channeler 104. In a preferred embodiment, the buffer interface 102 also comprises a tapered section 106 that may rest in an opening of the display. In this way, the vent may fit the display opening despite variations in hole size due to manufacturing tolerances. In the preferred embodiment, the tapered section acts like a stopper and has a diameter that tapers from a size larger than the display opening to a size smaller than the display opening. FIGS. 4-6 show the same views, structures and concepts for a three-hole vent design.

The buffer interface may be made of thermoplastic rubber or any other material that can beneficially absorb forces between the display part and the vent. In addition, the buffer interface preferably has good gripping properties so that the vent is not easily disconnected from the display. Preferably, it is also made of a dishwasher and food safe material.

FIGS. 7 and 8 show a vent 700 that has an inward hole slope 702 that leads to the perimeter of its vent holes. Although vent 700 with inward hole slope 702 shows a four-hole variation, it may be used with the three-hole variation as shown in FIGS. 4-6, with a two-hole variation, or with some other hole variation. This inward hole slope 702 is in contrast to the right angle cut of the vent hole perimeter shown in FIGS. 1 through 6. More preferably, the inward hole slope 702 continues past the plane of the vent underside so as to form one or more protruding inlets 710 on the underside of the vent.

In a preferred embodiment, the protruding inlet comprises a buffer interface locator. According to this aspect, the buffer interface preferably has the substantially reciprocal shape of a vent having one or more protruding inlets. In that way, the protruding inlet can help locate the buffer interface on the underside of the vent when connecting the vent and buffer interface together since it forces a limited number of connecting positions. This is very useful when the buffer interface is manually glued to the underside of the vent. It helps reduce the chance the buffer interface will be attached in a way that covers part of a vent hole.

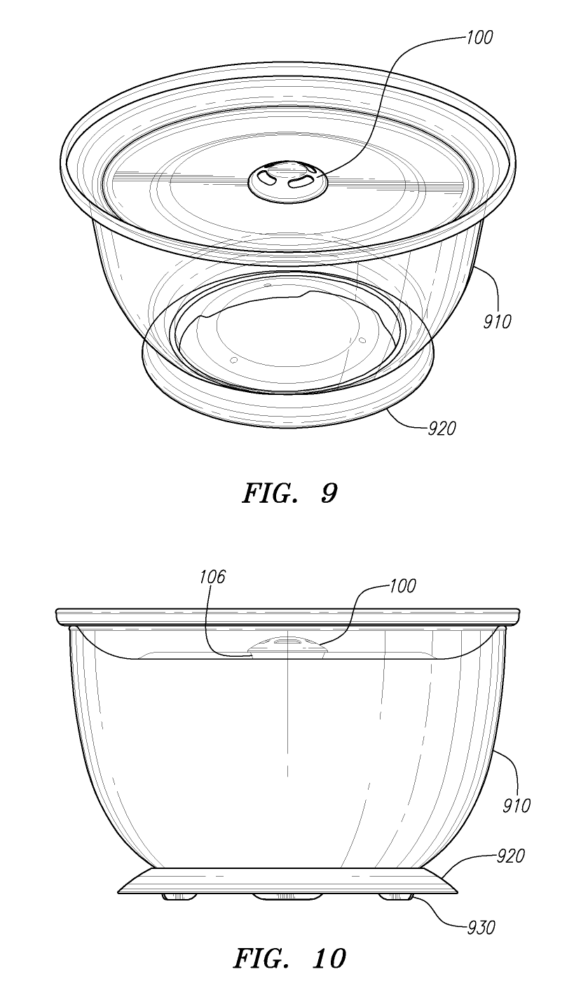

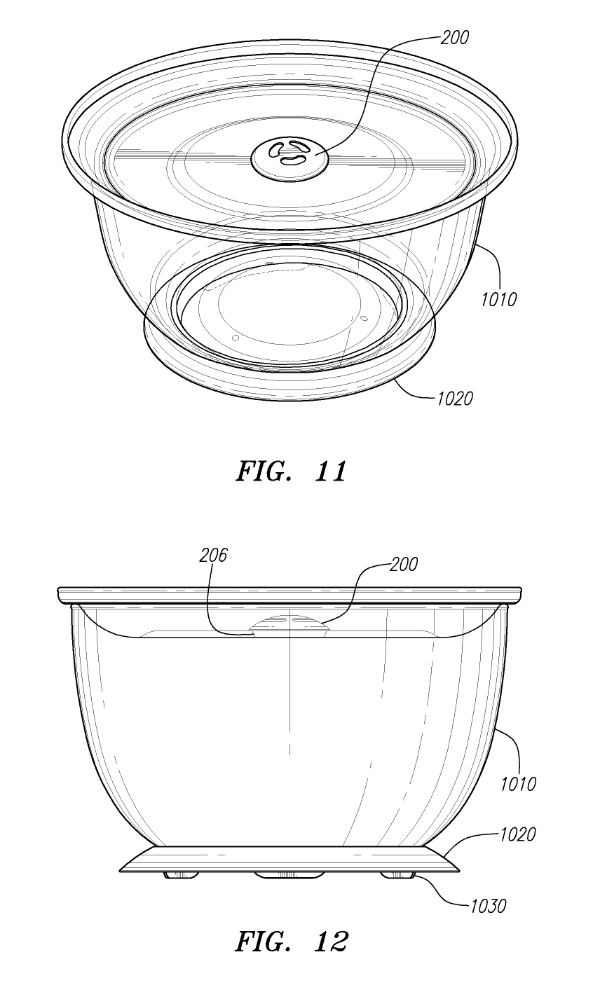

FIGS. 9 and 10 show a fruit ripening display in which the vent 100 and buffer interface 102 may be used. Alternately, the vent 700 with inward hole slope 702 leading to the perimeter of its vent holes may be used, preferably along with a substantially reciprocally contoured buffer interface. More preferably the buffer interface also further comprises a tapered section. The fruit support surface 900 may be glass or other material and has a hole (not shown) that permits gas exchange between the fruit ripener display chamber and the outer atmosphere through vent 100 or 700. The tapered section 106 of the buffer interface 102 is visible in FIG. 10. FIGS. 11 and 12 show the same views and concepts as FIGS. 11 and 12 for a three-hole vent design. Other vents, vent hole configurations and vent hole shapes may be used.

In another aspect, interfaces may be attached to other parts of the fruit ripener display. For example, an interface, preferably one made of thermoplastic rubber, may interface between display part 910 and the display support portion of base part 920 of FIGS. 9 and 10. Likewise, feet 930 may have an interface, preferably one made of thermoplastic rubber, between them and the table top. This also applies to the embodiment of FIGS. 11 and 12.

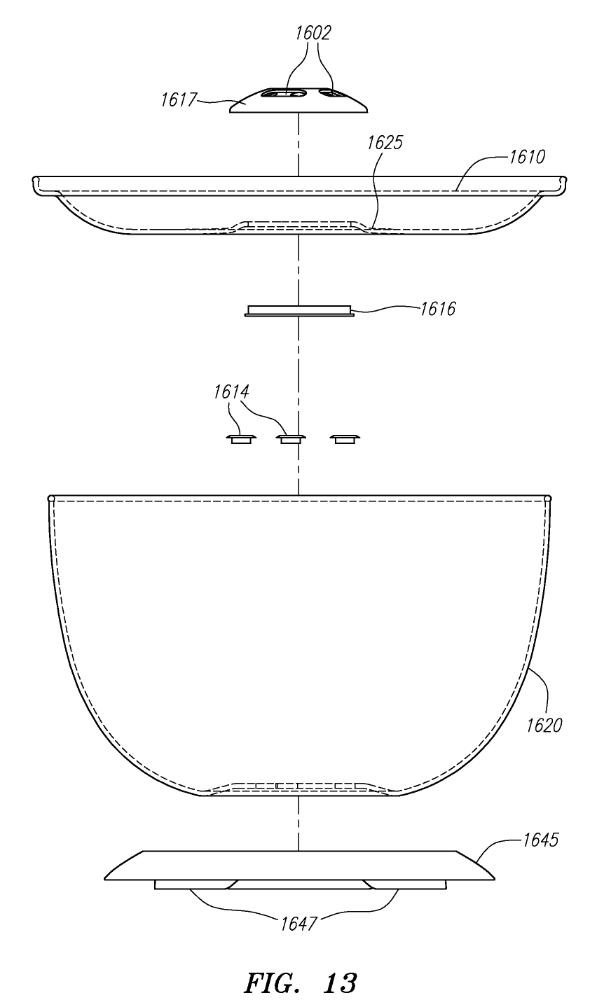

As shown in FIG. 13, various vent connectors may be made of a preferred interface material, such as thermoplastic rubber, that absorbs force between the vent and the fruit support surface. For example, items 1616, 1625, and the underside of 1617 may be made all or in part of an interface material, such as thermoplastic rubber. The vent could be pressure fit, glued or otherwise connected to the fruit support surface via some or all of these interfaces.

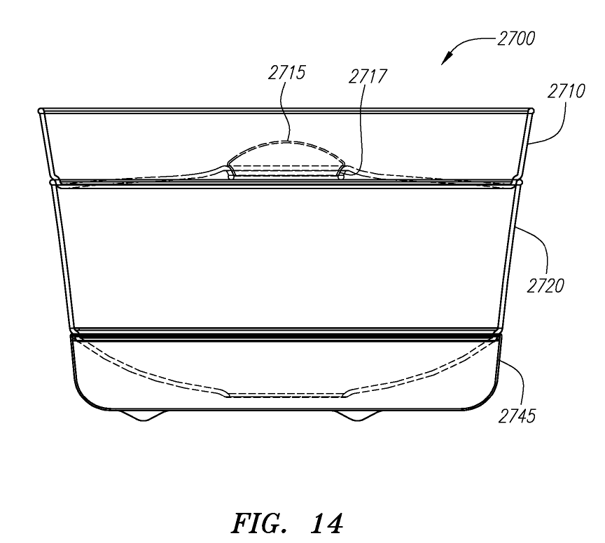

As shown in FIG. 14, the vent 2715 may itself comprise or consist of an interface material, such as thermoplastic rubber, that helps absorb forces between the vent and fruit support surface. The vent 2715 preferably comprises an integral tapered section 2717 made of an interface material.

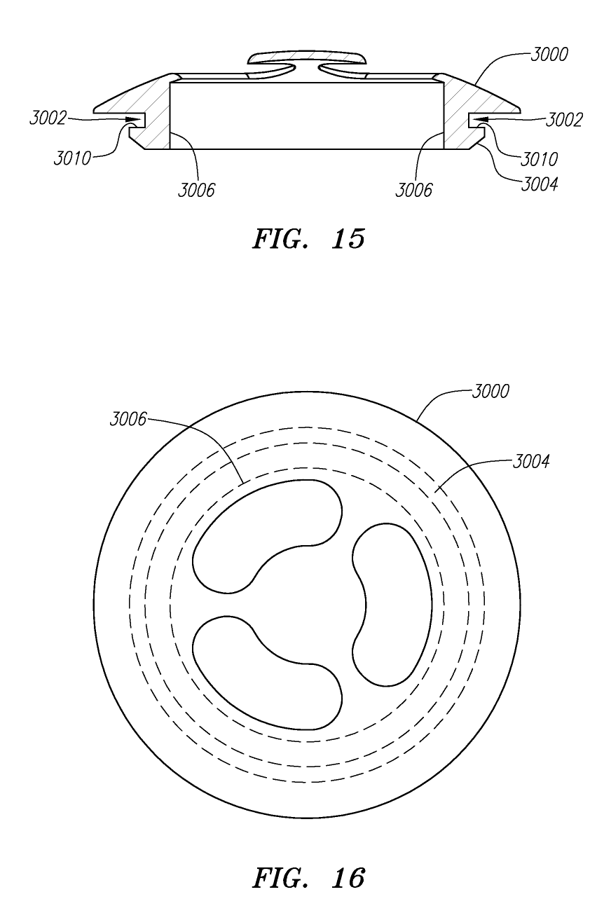

As shown in FIGS. 15 and 16, the buffer interface 3000 may comprise a groove 3002 and lock 3004. In this embodiment, the lock forms an entire perimeter of the buffer interface, thereby giving the lock a ring shape. Although this locking ring may be circular (as shown) it may have other shapes. To attach the vent-buffer interface assembly to the fruit ripening display part, the locking ring is placed through an opening in the fruit ripening display part whose own perimeter is preferably equal to or less than the locking ring perimeter at their points of contact. The groove, whose height should accommodate the thickness of the display part, then receives the display part's edge. The display part is thus bounded by the upper portion of lock 3004.

The buffer interface of this embodiment may also comprise an air flow channeler 3006, which itself may comprise a surface of the locking ring. Although the flow channeler as shown vertically channels air flow through the vent and away from the vent's outer perimeter, it may be of other thicknesses, orientations and locations such that it channels air passing through the vent away from the vent's natural contour. The buffer interface of this embodiment may also have a substantially reciprocal contour relative to at least one of said one or more said fruit ripening display vents at its point of contact. Further, the buffer interface of this embodiment may be located on a vent (not shown) by one or more vent protrusions that comprise a buffer interface locator.

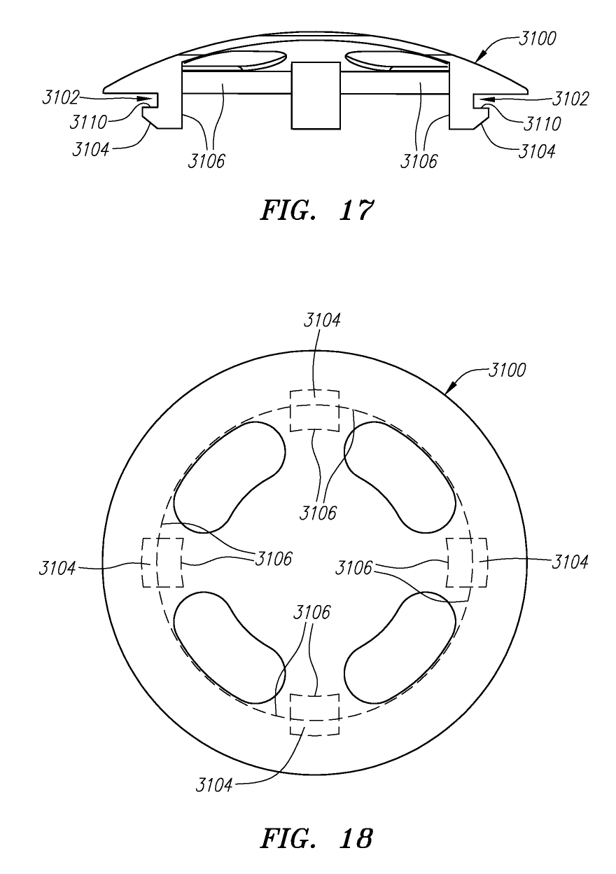

In a most preferred embodiment, shown in FIGS. 17 and 18, the buffer interface 3100 may comprise one or more partial grooves 3102, with the lock comprised of one or more locking tabs 3104. Although the locking tabs may be orientated along the perimeter of a circle (as shown), they may be provided in a different orientation. To attach the vent-buffer interface assembly to the fruit ripening display part, the locking tabs are placed through an opening in the fruit ripening display part whose own perimeter is preferably as narrow or narrower than the distance between the locking tabs at the points of contact. The groove, whose height should accommodate the thickness of the display part, then receives the display parts edge. The display part is thus bounded by the upper portion of one or more locking tabs 3104.

The buffer interface of this embodiment may also comprise an air flow channeler 3106, which may itself comprise a locking tab surface. Although the flow channeler as shown vertically channels air flow through the vent and away from the vent's outer perimeter, it may be of other thickness, orientations and locations such that it channels air passing through the vent away from the vent's natural contour. The buffer interface of this embodiment may also have a substantially reciprocal contour relative to at least one of said one or more said fruit ripening display vents at its point of contact. Further, the buffer interface of this embodiment may be located on a vent (not shown) by one or more vent protrusions that comprise a buffer interface locator. In the case of these and other embodiments disclosed herein, the vent and the buffer interface can be made of a uniform material and form an integral unit having the foregoing configurations.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. A fruit ripening display comprising
a) one or more fruit ripening display parts;
b) one or more fruit ripening display vent inserts;
c) a buffer interface connecting at least one of said one or more fruit ripening display parts to at least one of said one or more fruit ripening display vent inserts.

16. The fruit ripening display of claim 15 wherein said buffer interface comprises a lock.

17. The fruit ripening display of claim 16 wherein said buffer interface further comprises an air flow channeler that seals off space inside at least one of said one or more said fruit ripening display vent inserts.

18. The fruit ripening display of claim 15 wherein said buffer interface has a substantially reciprocal contour relative to at least one of said one or more said fruit ripening display vent inserts.

19. The fruit ripening display of claim 15 wherein said vent insert comprises one or more protrusions that comprise a buffer interface locator.

20. The fruit ripening display of claim 19 wherein at least one of said one or more protrusions is a protruding inlet.

21. The fruit ripening display of claim 18 wherein said buffer interface is grooved to accept at least one of said one or more fruit ripening display parts.

22. The fruit ripening display of claim 21 wherein said buffer interface further comprises an air flow channeler.

23. The fruit ripening display of claim 18 wherein the buffer interface comprises a lock.

24. The fruit ripening display of claim 23 wherein said lock is a locking ring.

25. The fruit ripening display of claim 23 wherein said lock comprises a tapered edge.
